(19) United States
(12) Patent Application Publication
(10) Pub. No.: US 2009/0240499 A1
(43) Pub. Date: Sep. 24, 2009

(54) LARGE VOCABULARY QUICK LEARNING SPEECH RECOGNITION SYSTEM

(76) Inventors: Zohar Dvir, Tel Aviv (IL); Ben-Zion Elishakov, Ashdod (IL); Eitan Broukman, Tel Aviv (IL); Yoel Shor, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/051,052

(22) Filed: Mar. 19, 2008

(51) Int. Cl. G10L 15/00

(52) U.S. Cl. 704/246; 704/E15.001

(57) ABSTRACT

A speech recognition system comprising: an analog to digital converter, a time to frequency transformer, a noise filter; a context preprocessor, an acoustic word classifier, an initial acoustic model generator, a textual search module, and a trainer. The system recognizes speech initially prior to training, due to the context preprocessor classifying words of identical sound by the context of a leading and trailing neighboring group of words and by the acoustic model generator creating an initial acoustic model derived from an acoustic word statistical analysis ‘average’. Applications of the system include voice activated computer games, command and control systems and text dictation.

### FIELD OF THE INVENTION

The present invention generally relates to speech recognition systems. The present invention particularly relates to fast learning speech recognition systems applicable to computer games.

### BACKGROUND OF THE INVENTION

One of the foremost aspects of the high-speed advancement in communications entails providing unrestricted access to multimedia services. One of the major contributors to an effortless and excessive multimedia access are user interfaces which are seamless, easy-to-use, high quality and capable of sustaining immense amount of bi-directional data exchange between people and computers. Spoken Language Interface (SLI) developed in recent years is one of the major contenders to becoming a main user-friendly interface between computers to their users. There have been numerous attempts to make voice interface system realize this technological vision. Although there are a large number of manners by which a user can have intelligent interactions with a machine, e.g., speech, text, graphical, touch screen, mouse, etc., it can be argued that speech is the most intuitive and most natural communicative type for most of the user population. The argument for speech interfaces is further reinforced by the abundance of speakers and microphones attached to personal computers, which facilitate universal remote and direct access to intelligent services.

Speech recognition technology has matured substantially in the past few years, with the first generation of products using speech recognition, launched already in the market. These products typically support only a very small set of commands. Hence, speech recognition technology is now focused on a second generation of spoken-language interfaces, which are more collaborative and conversational. This second generation of speech recognition technology presents significant technological challenges to the speech recognition field.

Computers are still designed with a keyboard and a mouse as integral user interface devices. Thus, applications are mostly utilizing keyboard and mouse inputs. Any user that has more than a few hours of experience with a PC becomes familiar with the use a mouse and keyboard. However it is quite frustrating for a novice user to figure out how to push the mouse and click. Speech recognition is by far a more natural user input “device”, than the keyboard or mouse. Nevertheless, talking to a computer is a new experience to a user and just like novice users are uncertain how to wield a mouse, users newly introduced to speech recognition are uncertain of how to use the microphone and what to say to the computer.

Application developers have also to overcome a learning curve related to the diversity of human speech sound.

U.S. Pat. No. 5,146,503 incorporated herein by reference, discloses a speech recognition system that comprises a recognizer for receiving speech signals from users. The recognizer compares each received word with templates of words stored in a reference template store and flags each template that corresponds most closely to a received word. The flagged templates are stored in template store. The recognizer compares the speech pattern from a given user of a second utterance of a word for which a flagged template is already stored in the template store with the templates stored in the reference template store and with the flagged templates in the template store so as to produce a second flagged template of that word. The second flagged templates are also stored in the template store. Sifting means analyze a group of flagged templates of the same word, and produce there from a second, smaller group of templates of the word. These templates are stored in another template store.

U.S. Pat. No. 5,027,406 incorporated herein by reference, discloses a method for creating word models for a large vocabulary, natural language dictation system. A user with limited typing skills can create documents with little or no advance training of word models. As the user is dictating, the user speaks a word, which may or may not already be in the active vocabulary. The system displays a list of the words in the active vocabulary which best match the spoken word. By keyboard or voice command, the user may choose the correct word from the list or may choose to edit a similar word if the correct word is not on the list. Alternately, the user may type or speak the initial letters of the word. Then the recognition algorithm is called again satisfying the initial letters, and the choices displayed again. A word list is then also displayed from a large backup vocabulary. The best words to display from the backup vocabulary are chosen using a statistical language model and optionally word models derived from a phonemic dictionary.

U.S. Pat. No. 6,694,296 incorporated herein by reference, discloses a speech recognizing system including a dictation language model providing a dictation model output indicative of a likely word sequence recognized based on an input utterance. A spelling language model provides a spelling model output indicative of a likely letter sequence recognized based on the input utterance. An acoustic model provides an acoustic model output indicative of a likely speech unit recognized based on the input utterances. A speech recognition component is configured to access the dictation language model, the spelling language model and the acoustic model. The speech recognition component weighs the dictation model output and the spelling model output in calculating likely recognized speech based on the input utterance. The speech recognition system can also be configured to confine spelled speech to an active lexicon.

U.S. Pat. No. 6,633,846 incorporated herein by reference, discloses a real-time system incorporating speech recognition and linguistic processing for recognizing a spoken query by a user and distributed between client and server. The system accepts user's queries in the form of speech at the client where minimal processing extracts a sufficient number of acoustic speech vectors representing the utterance. These vectors are sent via a communication channel to the server where additional acoustic vectors are derived. Using Hidden Markov Models and appropriate grammars and dictionaries conditioned by the selections made by the user, the speech representing the user's query is fully decoded into text (or some other suitable form) at the server. This text corresponding to the user's query is then simultaneously sent to a natural language engine and a database processor where optimized Structured Query Language (SQL) statements are constructed for a full-text search from a database for a record set of several stored questions that best matches the user's speech.

Speech recognition systems are categorized into several different classes by the types of utterances they are able to recognize. Most systems fit into more than one class, depending on their operational mode, ranging from the easiest speech recognition problem of isolated utterance recognizers which require each utterance to have quiet on both sides of the sample window, to the most intricate speech recognition problem of continuous utterance recognition. Recognizers with continuous speech capabilities are some of the most difficult to create because they must utilize special methods to determine utterance boundaries. Continuous speech recognizers allow users to speak almost naturally, while the computer determines the content. The technology is applicable computer dictation, which is the most common use for speech recognition systems today. This includes medical transcriptions, legal and business dictation, as well as general word processing. In some cases special vocabularies are used to increase the accuracy of the system. Speech recognition systems that are designed to perform functions and actions by the user uttering commands are defined as Command and Control systems. The widespread command and control speech recognition systems commonly start with a frequently tedious training process used by the system to recognize the voice pattern of the user. Dictation systems further need lots of exemplary training data to reach their optimal performance. Training is sometimes on the order of thousands of hours of human-transcribed speech and hundreds of megabytes of text. These training data are used to create acoustic models of words, word lists, and multi-word probability networks. Hence there is still a long felt need for quick learning speech recognition system applicable to the entire spectrum of speech recognition problems.

### SUMMARY OF THE INVENTION

It is the object of the present invention to disclose a speech recognition system comprising: an analog to digital converter, a time to frequency transformation module, a noise filter, a context preprocessor, an acoustic word classifier, an initial acoustic model generator, a textual search module and a trainer, wherein said system recognizes speech, independent of a speaker, prior to training, due to the context preprocessor classifying different words of identical sound by analyzing the words in the context of several leading and trailing neighboring words and due to the acoustic model generator creating an initial acoustic model derived from a statistical analysis ‘average’ of the acoustic word.

Another object of the present invention and any of the above is to disclose a speech recognition system, wherein the context preprocessor further comprises a buffer for storing an acoustic word with a first group of consecutive leading acoustic words, and a second group of consecutive trailing acoustic words.

Another object of the present invention and any of the above is to disclose a speech recognition system, further comprising a language model and a dictionary database.

Another object of the present invention and any of the above is to disclose a speech recognition system, wherein the trainer utilizes user feedback for adapting the acoustic model to user speaker dependent features and system vocabulary.

Another object of the present invention and any of the above is to disclose a speech recognition system, usable for a small vocabulary or a large vocabulary.

Another object of the present invention and any of the above is to disclose a speech recognition system, wherein the system is distributed amongst several computers.

Another object of the present invention and any of the above is to disclose a speech recognition system, wherein the noise filter maximizes signal to noise ratio of the acoustic words.

It is the object of the present invention to disclose a voice activated computer game comprising:

a voice recognition system comprising: an analog to digital converter, a time to frequency transformation module, a noise filter, a context preprocessor classifying different words of identical sound by analyzing the words in the context of leading and trailing neighboring words, an acoustic word classifier, an initial acoustic model generator generating an initial acoustic model derived from a statistical analysis ‘average’ of the acoustic words, a textual search module, and a trainer and an application-programming interface operable by the voice recognition system output.

wherein player-uttering instructional commands are usable for operating the computer game prior to player speech dependent training and adaptable to the player dependent speech features in a substantial fast training process.

Another object of the present invention and any of the above is to disclose a voice activated computer game, wherein the speech recognition system is embedded into a computer game console.

Another object of the present invention and any of the above is to disclose a voice activated computer game, wherein the speech recognition system is distributed amongst several computers.

Another object of the present invention and any of the above is to disclose a voice activated computer game, wherein the computer game user interface combines voice activation with presently used input devices.

It is the object of the present invention to disclose a speech recognition method, comprising: obtaining a speech recognition system comprising: an analog to digital converter, a time to frequency transformer, a noise filter, a context preprocessor, an acoustic word classifier, an initial acoustic model generator, a textual search module and a trainer; converting speech analog signal into a sequence of digital words, transforming a time varying digital data into a frequency domain, filtering noise out of the speech digital data, preprocessing acoustic words by context of neighboring words, acoustic model initializing, speech content recognizing and training the system by speaker dependent speech features.

wherein the method is accommodating speech recognition prior to training, independent of a speaker speech pattern, due to the context preprocessing classifying different words of identical sound by analyzing the words in the context of several leading and trailing neighboring words and due to the acoustic model generating creating an initial acoustic model derived from a statistical analysis ‘average’ of the acoustic words.

Another object of the present invention is to disclose a speech recognition method, wherein the training is accommodating user feedback to the system for adapting the acoustic model to the user speaker speech characteristics and to usable vocabulary.

Another object of the present invention is to disclose a speech recognition method, usable for small or large vocabulary.

Another object of the present invention is to disclose a speech recognition method, embedded into a single computer or distributed amongst several computers.

### BRIEF DESCRIPTION OF THE DRAWING AND FIGURES

In order to understand the invention and to see how it may be implemented in practice, a plurality of preferred embodiments will now be described, by way of non-limiting example only, with reference to the accompanying drawing, in which:

FIG. 1 illustrates schematically a general block diagram of a speech recognition system, according to an embodiment of the present invention;

FIG. 2 illustrates schematically a detailed block diagram of the pre-processing portion of a speech recognition system, according to an embodiment the present invention;

FIG. 3 illustrates schematically a detailed block diagram of the language processing portion of a speech recognition system, according to an embodiment the present invention;

FIG. 4 illustrates schematically a block diagram of voice activated computer game, according to an embodiment the present invention; and

FIG. 5 illustrates schematically a flow chart of a method used by the speech recognition system, according to an embodiment the present invention;

### DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide a speech recognition system.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments.

The drawings set forth the preferred embodiments of the present invention. The embodiments of the invention disclosed herein are the best modes contemplated by the inventors for carrying out their invention in a commercial environment, although it should be understood that various modifications could be accomplished within the parameters of the present invention.

The term ‘utterance’ relates hereinafter in a non-limited manner to speaking of a word or words that represent a single meaning to the computer. Utterance can be a single word, a few words, a sentence, or even multiple sentences.

The term ‘Speaker dependence’ relates hereinafter in a non-limiting manner to systems designed around a specific speaker. These systems are generally more accurate for the correct speaker, but much less accurate for other speakers. They assume the speaker will speak in a consistent voice and tempo. Speaker independent systems are designed for a variety of speakers. Adaptive systems usually start as speaker independent systems and utilize training techniques to adapt to the speaker to increase their recognition accuracy.

The term ‘training’ relates hereinafter in a non-limiting manner to the ability to adapt to a speaker and a system vocabulary. When the system has this ability, it may allow training to take place. A voice recognition system is trained by having the speaker repeat standard or common phrases and adjusting its comparison algorithms to match that particular speaker.

The term ‘Speech Application Programming Interface (SAPI)’ relates hereinafter in a non limiting manner to an application programming interface developed commercially to allow the use of speech recognition and speech synthesis within existing computing platforms.

The term ‘phoneme’ relates hereinafter in a non limiting manner to the smallest phontic units of speech which are the basic building blocks of uttered words. The English language includes about fourty phonemes.

The term ‘homonyms’ relates hereinafter in a non limiting manner to words that are spelled differently and have different meanings but sound the same. “there” and “their” “air” and “heir,” “be” and “bee” are all examples.

The term ‘Hidden Markov Model (HMM)’ relates hereinafter in a non limiting manner to a statistical model in which the system being modeled is assumed to be a Markov process with unknown parameters, and the challenge is to determine the hidden parameters from the observable parameters.

The term ‘Markov process’ relates hereinafter in a non limiting manner to is a discrete-time stochastic process with the Markov property. Having the Markov property means for a given process that knowledge of the previous states is irrelevant for predicting the probability of subsequent states. This way a Markov chain is “memoryless”: no given state has any causal connection with a previous state.

The term ‘Structured Query Language (SQL)’ relates hereinafter in a non limiting manner to a computer language designed for the retrieval and management of data in relational database management systems, database schema creation and modification, and database object access control management.

The term ‘Nyquist-Shannon sampling theorem’ relates hereinafter in a non limiting manner to the theorem that states that exact reconstruction of a continuous-time baseband signal from its samples is possible if the signal is bandlimited and the sampling frequency is greater than twice the signal bandwidth.

The term ‘system transfer function’ relates hereinafter in a non-limiting manner to a mathematical representation of the relation between the input and output of a linear time-invariant system.

The present invention provides speech recognition with low textual error probability combined with a fast learning curve due to a novel speech recognition technique. The technique is characterized by a preliminary acoustic word recognition routine at the pre-processing portion by analyzing a word in the context of several leading and trailing neighboring words. The technique is further characterized by an acoustic model generator at the language decoding portion of the system creating an initial acoustic model derived from a statistical analysis ‘average’ of the acoustic words. Consequently, a large vocabulary speech recognition system according to this invention, yields initially prior to training, a substantially low error rate of speaker independent speech recognition and requires a substantially short training process to reach a higher level of performance.

Large vocabulary speech recognition systems are commonly intended for dictation applications. The present invention is presently directed in a non-limiting manner to voice activated computer games.

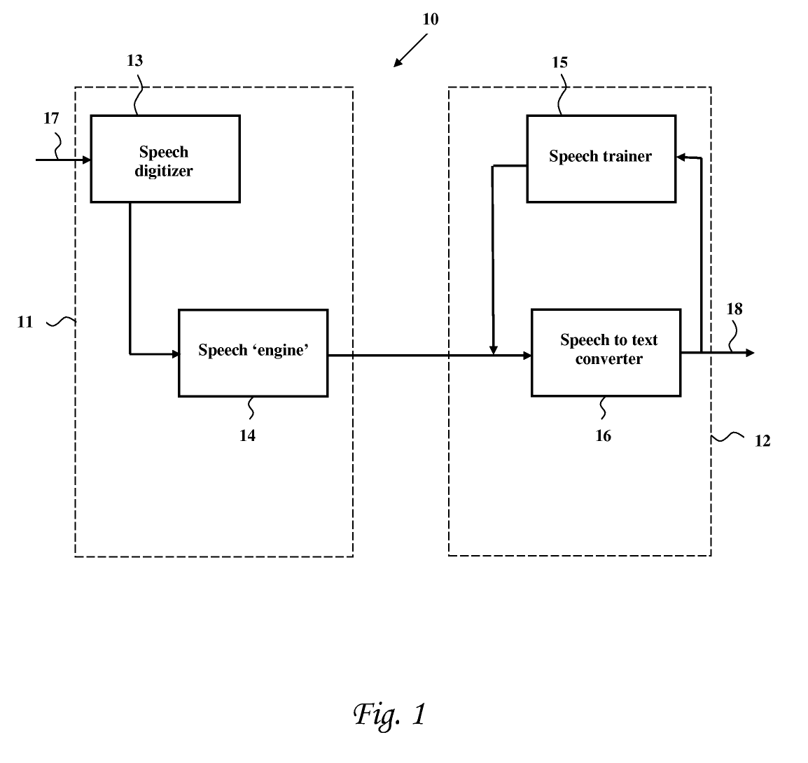

Reference is now made to FIG. 1 a block diagram of the speech recognition system. Numerous available products provide an infrastructure to a speech recognition system. These infrastructures provide an environment usable by the application builder to yield effortlessly distinct voice recognition application. The system of present invention is similarly built on the structural foundations of a commercial voice recognition infrastructure product. Speech recognition system 10 comprises a preprocessor sub-system 11 and a language processor sub-system 12. Pre-processor 11 analyzes the acoustic characteristics of the speech signal by extracting acoustic language features, which are passed along to language processor 12. Language processor 12 converts speech utterance to textual data while learning distinct speech characteristics of a speaker in a feedback learning process. Preprocessor 11 includes a speech digitizer module 13 extracting sampled digital words from analog speech signal 17. The digital data is passed along to speech engine 14 for acoustic pre-processing. Language processor 12 includes a speech to text converter module 16 providing system output and a speech trainer 15 adapting the system to minimize errors for a distinct speaker.

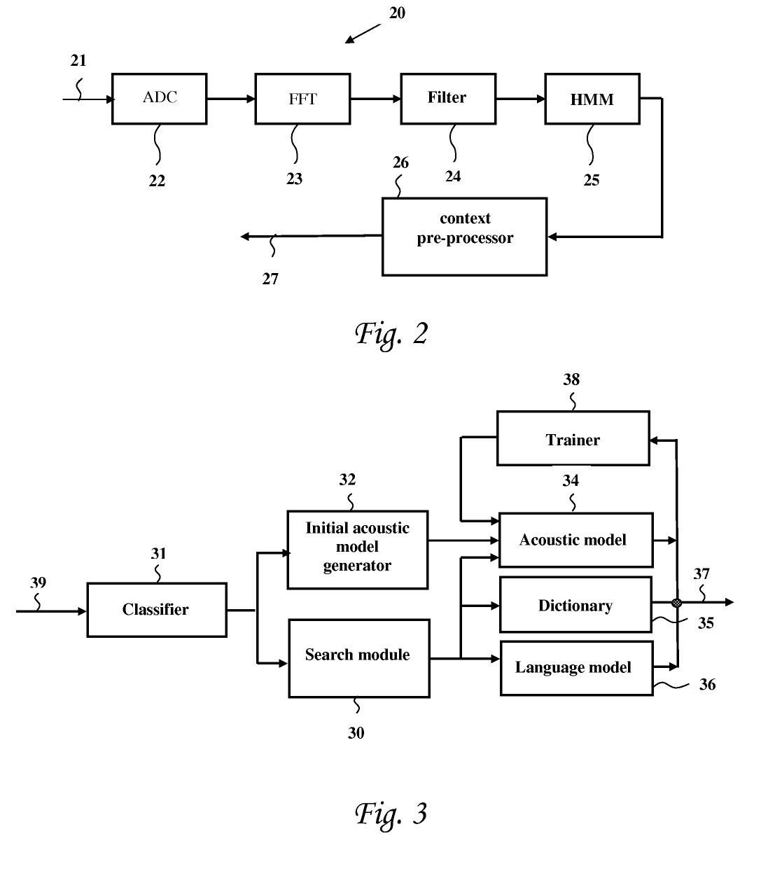

Reference is now made to FIG. 2 the block diagram of pre-processor sub-system 20, which is the front-end portion of the system. This portion of the speech recognition system commonly analyzes the acoustical aspects of the of the speech input. Incoming speech, an audio signal 21 is sampled by an Analog to Digital Converter (ADC) 22 extracting an associated sequence of digital words. The sampling rate of ADC 22 is determined by the maximum bandwidth of the speech signal spectrum multiplied at least by two, according to the Nyquist-Shannon sampling theorem. A Fast Fourier Transform (FFT) module 23 transforms the time varying sequence of words into the frequency domain allowing for filtering noise data by utilizing complex transfer function of filter module 24. The filter outputs combinations of phonemes, i.e. the basic speech units, which are the building blocks of speech analysis. The sequence of phonemes is further processed by a Hidden Markov Model (HMM) 25, constructing words from phoneme sequences to generate a phonetic words. The pre-processor modules described in the preceding section are commonly included in the infrastructure of a commercial speech recognition system. The present invention however, introduces a new context preprocessor module 26 to the standard modules of the commercial product. This module creates consecutively, sequences of several consecutive words, in a buffer and analyzes statistically the central word of those buffered sequences in the context of the neighboring words. The analysis of a word in the context of several neighboring words promotes word detection accuracy and is specifically useful for finding out the correct word for homonyms by discriminating words having the same sound according to their context in a neighboring group of words. The context preprocessor module 26 outputs a sequence of words 27 into the language processor.

Reference is now made to FIG. 3 the detailed block diagram of language processor. The task performed by the language processor is quite demanding considering that the number of possible combinations used in oral conversation, which is quite literally infinite. Another level of complexity of a speech language processor is related to the distinct sound of different people because people don't pronounce words the same way. Everyone speaks at a different speed too, so the length of each phoneme is yet another variable. Since each phoneme model represents average of different durations, speaking either slower or faster than the trained reference phonemes can limit the accuracy of the system. In practice, the speech-recognition system must try to find the best alignment of the reference phoneme model, comparing it with the recording being transcribed. The language processor analyses a sequence of acoustically represented words 39 generated by the preprocessor subsystem and enters a classifier module 31 which classifies the incoming words by their sound properties. The classified word sounds enter a search module 30 and an initial acoustic model generator module 32. The search module 30 uses a dictionary data base 35, the acoustic model 34 and a language model 36 for generating the final text decoded output 37. A trainer 38 is a module that is commonly used by speech recognition system. Rule-based methods of speech decoding, are commonly avoided since it is impractical to write rules to describe all of speech and language-particularly since people rarely speak in grammatical sentences, and language is evolving all the time. A general framework is filled with derived information from many real-world examples of speech and language applied to the trainer. A simple speech recognizer, capable of transcribing only single-word utterances, can be trained with just a dictionary and some speech recordings. To begin with, the system must be given a set of speech recordings, and “told” which phoneme is which by noting exactly when a phoneme begins and when it ends. The trainer 38 is used as in other speech recognition systems to learn the distinct speech attributes of the speaker. Nevertheless, the present, invention has an incorporated initial acoustic model generator 32 using an ‘average’ acoustic model, statistically generated at the beginning of the system operation. Spoken utterences of a user are transcribed initially by the language processor prior to any learning step of the trainer. Hence, the system is adapted substantially adequately independent of a user's voice, from the beginning and subsequent learning steps of the trainer are just used to enhance the system performance whereas tedious initial learning steps are not required.

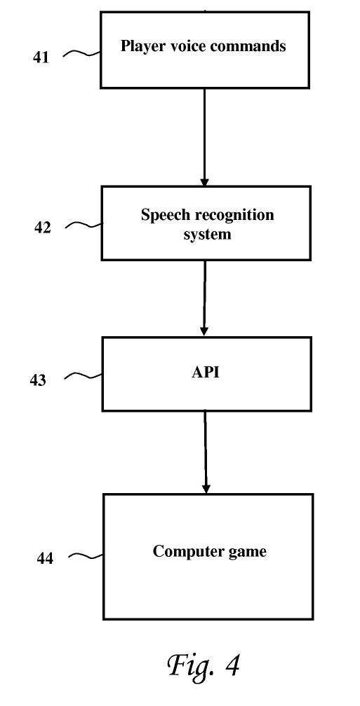

Reference is now made to FIG. 4 which is a block diagram of a voice activated computer game an embodiment of the present invention. This enables the player to play computer games while keeping his hands free rather than by hand maneuvering input devices like a joystick, a keyboard or a mouse or any combination of the above in a non limiting manner. Furthermore, a user may play the game entirely by voice activated commands, or partially by a combination of speech commands with any of the input devices presently used for computer games. Player voice commands 41 are identified by a speech recognition system 42. The speech recognition system enters an Application Programming Interface 43 like any other input device and used to manipulate actions of computer game 44. The voice activating system of a computer game requires a limited vocabulary similar to command and control applications thus required memory and computational resources are substantially limited. The system may be embedded into console game or alternatively into a web game which is recently widespread. Computer game resources can be spared by having a voice recognition architecture with the preprocessor embedded into the player computer or alternately when the system is entirely embedded into the player computer. Player profile in the present invention, which is acquired during system training, is exportable, following a player to another playing platform hence having a personal profile of a player following the player.

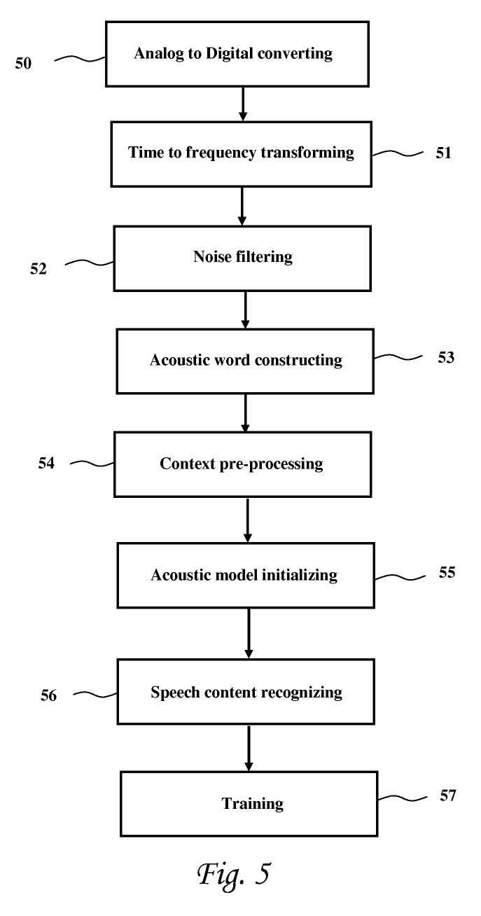

Reference is now made to FIG. 5 which is a flow chart of the method used by the speech recognition system in one embodiment of the present invention. The method used by the speech recognition system starts with converting the analog audio signal representing the speech into a sequence of digital words in step 50. The conversion rates and the sample number of bits are determined by system accuracy considerations. The generated sequence of digital words are converted into the frequency domain in a time to frequency transforming (FFT) step 51. The following data analysis steps are conducted with frequency converted data. Analysis begins with noise filtering in step 52 for improving signal to noise ratio of the data. Data analysis follows with acoustic word constructing in step 53 commonly implemented by known Hidden Markov Model (HMM). Data analysis follows with the unique context preprocessing function of the present invention in step 54 associated with buffering several consecutive words and analyzing words in the context of those several leading and trailing neighboring words. Data analysis follows with another unique acoustic model initializing step 55 operable to initialize the acoustic model by utilizing a statistical ‘average’ acoustic model hence accommodating initial speech content recognizing in step 56 at an adequate level prior to any user voice learning. Data analysis ends with a training step 57 going on continuously providing user feedback, which is operable reduce probability of speech recognition error.

Present invention features low error rate combined with a short learning curve. The invention is usable with large vocabulary applications as dictation, as well as with small vocabulary applications as command and control and voice activated computer games. The system architecture allows for various configurations, selected from a list consisting of a single computer embedded system, distributed system embedded in several computers or any combination thereof.

It will be appreciated that the described methods may be varied in many ways including, changing the order of steps, and/or performing a plurality of steps concurrently.

It should also be appreciated that the above described description of methods and apparatus are to be interpreted as including apparatus for carrying out the methods, and methods of using the apparatus, and computer software for implementing the various automated control methods on a general purpose or specialized computer system, of any type as well known to a person or ordinary skill, and which need not be described in detail herein for enabling a person of ordinary skill to practice the invention, since such a person is well versed in industrial and control computers, their programming, and integration into an operating system.

For the main embodiments of the invention, the particular selection of type and model is not critical, though where specifically identified, this may be relevant. The present invention has been described using detailed descriptions of embodiments thereof that are provided by way of example and are not intended to limit the scope of the invention. No limitation, in general, or by way of words such as “may”, “should”, “preferably”, “must”, or other term denoting a degree of importance or motivation, should be considered as a limitation on the scope of the claims or their equivalents unless expressly present in such claim as a literal limitation on its scope. It should be understood that features and steps described with respect to one embodiment may be used with other embodiments and that not all embodiments of the invention have all of the features and/or steps shown in a particular figure or described with respect to one of the embodiments. That is, the disclosure should be considered complete from combinatorial point of view, with each embodiment of each element considered disclosed in conjunction with each other embodiment of each element (and indeed in various combinations of compatible implementations of variations in the same element). Variations of embodiments described will occur to persons of the art. Furthermore, the terms “comprise,” “include,” “have” and their conjugates, shall mean, when used in the claims, “including but not necessarily limited to.” Each element present in the claims in the singular shall mean one or more element as claimed, and when an option is provided for one or more of a group, it shall be interpreted to mean that the claim requires only one member selected from the various options, and shall not require one of each option. The abstract shall not be interpreted as limiting on the scope of the application or claims.

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

What is claimed is:

1. A speech recognition system capable of recognizing speech independent of a speaker prior to training, said system comprising:
a context preprocessor; operatively associated with
an acoustic word classifier; operatively associated with
an acoustic model generator;
wherein said context preprocessor operating in conjunction with said acoustic word classifier are configured to classify different words of identical sound by analyzing said words in the context of several leading and trailing neighboring words;
and wherein said acoustic model generator is configured to create an initial acoustic model derived from a statistical analysis of said acoustic word.

2. The speech recognition system according to claim 1, further comprising a trainer.

3. The speech recognition system according to claim 1, further comprising an analog to digital converter; a time to frequency transformation module and a noise filter.

4. The speech recognition system according to claim 1, wherein said context preprocessor further comprises a buffer for storing an acoustic word with a first group of consecutive leading acoustic words, and a second group of consecutive trailing acoustic words.

5. The speech recognition system according to claim 1, further comprising a language model and a dictionary database.

6. The speech recognition system according to claim 2, wherein said trainer utilizes user feedback for adapting said acoustic model to user speaker dependent features and system vocabulary.

7. The speech recognition system according to claim 1, wherein said system's component are distributed over a plurality of computers communicating between themselves.

8. The speech recognition system according to claim 3, wherein said noise filter maximizes signal to noise ratio of said acoustic words.

9. A voice activated computer game application comprising:
a voice recognition module implemented as a machine readable code comprising: a context preprocessor; operatively associated with an acoustic word classifier; operatively associated with an acoustic model generator; wherein said context preprocessor operating in conjunction with said acoustic word classifier are configured to classify different words of identical sound by analyzing said words in the context of several leading and trailing neighboring words;
an application-programming interface operable by said voice recognition system output; wherein player-uttering instructional commands are usable for operating said computer game prior to player speech dependent training and adaptable to said player dependent speech features in a substantial fast training process.

10. The computer game application according to claim 9, wherein said voice recognition module is embedded into the player's computer.

11. The computer game application according to claim 9, wherein said voice recognition module is embedded into a computer game console.

12. The computer game application according to claim 9, wherein said computer game user interface combines voice activation with presently used input devices.

13. A computer implemented method capable of recognizing speech independent of a speaker prior to training, said method comprising:
contextual preprocessing of incoming acoustic words;
classifying said acoustic words in the context of a plurality of leading and trailing neighboring words;
creating an initial acoustic model derived from a statistical analysis of said acoustic words.

14. The speech recognition method according to claim 13, further comprising training exhibiting user feedback to said system for adapting said acoustic model to said user speaker speech characteristics and to usable vocabulary.

15. The speech recognition method according to claim 13, further comprising exporting and importing external user profile on other computer for such that the other computer is enabled to recognize the user immediately with no training.
